(19) United States
(12) Patent Application Publication
(10) Pub. No.: US 2024/0328824 A1
(43) Pub. Date: Oct. 3, 2024

(54) POSE CALIBRATION METHOD FOR AEROSPACE MAGNETOMETER

(71) Applicant: Institute of Geology an Geophysics Chinese Academy of Sciences, Beijing (CN)

(72) Inventors: Zhi LI, Beijing (CN); Yasong GE, Beijing (CN); Lin ZHAO, Beijing (CN); Shuquan SUN, Beijing (CN); Xiao FENG, Beijing (CN)

(73) Assignee: Institute of Geology an Geophysics Chinese Academy of Sciences, Beijing (CN)

(21) Appl. No.: 18/434,835

(22) Filed: Feb. 7, 2024

(30) Foreign Application Priority Data
Mar. 28, 2023 (CN) 202310317859.4

(51) Int. Cl. G01C 25/00; G01C 21/08

(52) U.S. Cl. CPC G01C 25/00; G01C 21/08

(57) ABSTRACT

A pose calibration method for an aerospace magnetometer includes the following steps: mounting a magnetometer and a camera on a vehicle body; in the ground state, completely expanding a stretching rod mounted on the vehicle body, and taking photos from multiple angles by the camera in the Earth's full gravity mode; in the near-moon gravity mode, taking photos from multiple angles by the camera; comparing the photos in the Earth's full gravity mode and the near-moon gravity mode to obtain a reference database; and repeating S2 and S3 in an on-orbit state, and comparing the photographing result with the reference database to obtain a length and an angle of the stretching rod. According to the pose calibration method, the photographed structure in the on-orbit state is compared with the reference database to obtain the length and the angle of the stretching rod.

### CROSS REFERENCE TO THE RELATED APPLICATIONS

This application is based upon and claims priority to Chinese Patent Application No. 202310317859.4, filed on Mar. 28, 2023, the entire contents of which are incorporated herein by reference.

### TECHNICAL FIELD

The present invention relates to the technical field of magnetometer measurement, and more specifically, to a pose calibration method for an aerospace magnetometer.

### BACKGROUND

A magnetometer is an instrument for measuring magnetic induction intensity. The principle of the magnetometer is as follows: a small magnetic needle can deflect or vibrate under the action of a magnetic field, and according to the law of electromagnetic induction, for a closed loop with a given resistance, the change of magnetic flux in the loop can be known as long as the charge flowing through the loop is measured, which is used to detect the change of a geomagnetic field. The magnetometer is widely applied to the fields of industry, agriculture, transportation, national defense, aerospace, oceans, meteorology, medical treatment and health, and the like. In satellite attitude measurement and control, the satellite attitude information can be provided by measuring a space magnetic field with a magnetometer. The magnetometer load belongs to vector measurement load, and there are XYZ three components inside the magnetometer, so that the attitude and the orientation of the magnetometer will affect the three components of measurement data of the magnetometer. Therefore, the attitude information of the magnetometer must be accurate to ensure the accuracy of the measured data. However, the magnetometer in the conventional technologies is mounted on a stretching rod mechanism, the stretching rod mechanism is of a reel type and is extended by using a core elastic reel, and a rigid structure is formed after the elastic reel is extended to serve as a support structure of the magnetometer. The stretching rod is extended elastically, which causes that a length of the stretching rod is not fixed after the stretching rod is pressed to be extended every time, and an angle at which the rotation is completed is also not fixed, so that a position and a posture of the on-orbit magnetometer cannot be determined. Therefore, how to provide a method capable of accurately calibrating a pose of a magnetometer is a problem required to be solved urgently by those skilled in the art.

### SUMMARY

In view of this, the present invention provides a pose calibration method for an aerospace magnetometer, which accurately calibrates the pose of the magnetometer by comparing an image photographed by a high-resolution camera with a pre-obtained reference database.

In order to achieve the above objective, the present invention provides the following technical solution.

A pose calibration method for an aerospace magnetometer includes the following steps:
S1: mounting a magnetometer and a camera on a vehicle body;
S2: in the ground state, completely expanding a stretching rod mounted on the vehicle body, and taking photos from multiple angles by the camera in the Earth's full gravity mode;
S3: in the near-moon gravity mode, taking photos from multiple angles by the camera;
S4: comparing the photos in the Earth's full gravity mode and the near-moon gravity mode to obtain a reference database; and
S5: repeating S2 and S3 in an on-orbit state, and comparing the photographing result with the reference database to obtain a length and an angle of the stretching rod.

Optionally, in the S1, the magnetometer is mounted on a reel-type stretching rod mechanism on a side face of the vehicle body, and the camera is mounted on a mast at a front end of the vehicle body.

Optionally, an included angle between the stretching rod and a traveling vehicle is 45°, and the stretching rod rotates and stretches out obliquely forward.

Optionally, the S5 specifically includes:
S51: preprocessing the image;
S52: calculating a gradient and an angle of the image to obtain a gradient image;
S53: performing non-maximum suppression on the gradient image;
S54: connecting edges by a double-threshold method to obtain edge detection results; and
S55: comparing the edge detection results to obtain the length and the angle of the stretching rod in the on-orbit state.

Optionally, the preprocessing in the S51 specifically includes: firstly performing graying processing on the images to obtain a grayscale image, and performing Gaussian filtering with a kernel size of 5×5 on the grayscale image to obtain a preprocessed image.

Optionally, the performing non-maximum suppression on the gradient image in the S53 specifically includes: for one pixel point A, comparing a gradient strength of the pixel point A with a gradient strength of a pixel point in positive and negative directions of a gradient of the pixel point A, if the gradient strength of the pixel point A is maximum, reserving the pixel point A, and if not, setting the gradient of the pixel point A to be 0.

Optionally, the double-threshold method in the S54 specifically includes: comparing a gradient of a pixel point with a preset first threshold value and a preset second threshold value, wherein the first threshold value is greater than the second threshold value; if the gradient of the pixel point is greater than the first threshold value, reserving the pixel point; if the gradient of the pixel point is less than the second threshold value, setting the gradient of the pixel point to be 0; if the gradient of the pixel point is less than the first threshold value and greater than the second threshold value, performing separate determination; wherein the first threshold value is greater than the second threshold value.

It can be seen from the foregoing technical solution, compared with the prior art, the present invention discloses and provides a pose calibration method for an aerospace magnetometer, and the pose calibration method has the following beneficial effects: images in the Earth's full gravity mode and the moon gravity mode are separately photographed in the ground state to construct a reference database, and the photographed structure in the on-orbit state is compared with the reference database, so that a length and an angle of the stretching rod can be accurately obtained in a case that the length and the angle of the stretching rod cannot be fixed after the stretching rod is extended, and the measuring accuracy of the magnetometer is further ensured.

### BRIEF DESCRIPTION OF THE DRAWINGS

In order to more clearly illustrate the technical solutions in the embodiments of the present invention or in the prior art, the drawings required to be used in the description of the embodiments or the prior art are briefly introduced below. It is obvious that the drawings in the description below are embodiments of the present invention, and those of ordinary skill in the art can obtain other drawings according to the drawings provided herein without creative efforts.

FIG. 1 is a flow chart of a method according to the present invention;

FIG. 2 is a schematic diagram of a position of a magnetometer according to the present invention;

FIG. 3 is a structural diagram of a stretching rod according to the present invention;

FIG. 4 is a schematic diagram of a stretching rod according to the present invention in a retracted state; and

FIG. 5 is a schematic diagram of a stretching rod according to the present invention in an extension state.

In the drawings, 1: magnetometer, 2: camera, 3: stretching rod, 4: mast, 5: traveling vehicle, 6: ejector rod assembly, 7: elastic reel storage tank, 8: cable winding cylinder, and 9: pin puller.

### DETAILED DESCRIPTION OF THE EMBODIMENTS

The following clearly and completely describes the technical solutions in embodiments of the present invention with reference to the accompanying drawings in embodiments of the present invention. It is clear that the described embodiments are merely a part rather than all of embodiments of the present invention. Based on the embodiments of the present invention, all other embodiments obtained by those of ordinary skill in the art without creative efforts shall fall within the protection scope of the present invention.

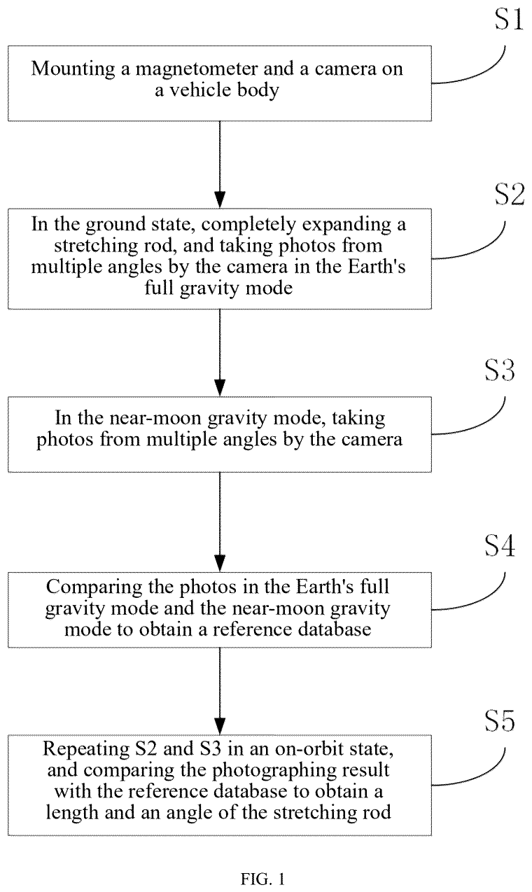

An embodiment of the present invention discloses a pose calibration method for an aerospace magnetometer. As shown in FIG. 1, the method includes the following steps:
S1: mounting a magnetometer 1 and a camera 2 on a vehicle body;
S2: in the ground state, completely expanding a stretching rod 3 mounted on the vehicle body 5, and taking photos from multiple angles by the camera 2 in the Earth's full gravity mode;
S3: in the near-moon gravity mode, taking photos from multiple angles by the camera 2;
S4: comparing the photos in the Earth's full gravity mode and the near-moon gravity mode to obtain a reference database; and
S5: repeating S2 and S3 in an on-orbit state, and comparing the photographing result with the reference database to obtain a length and an angle of the stretching rod 3.

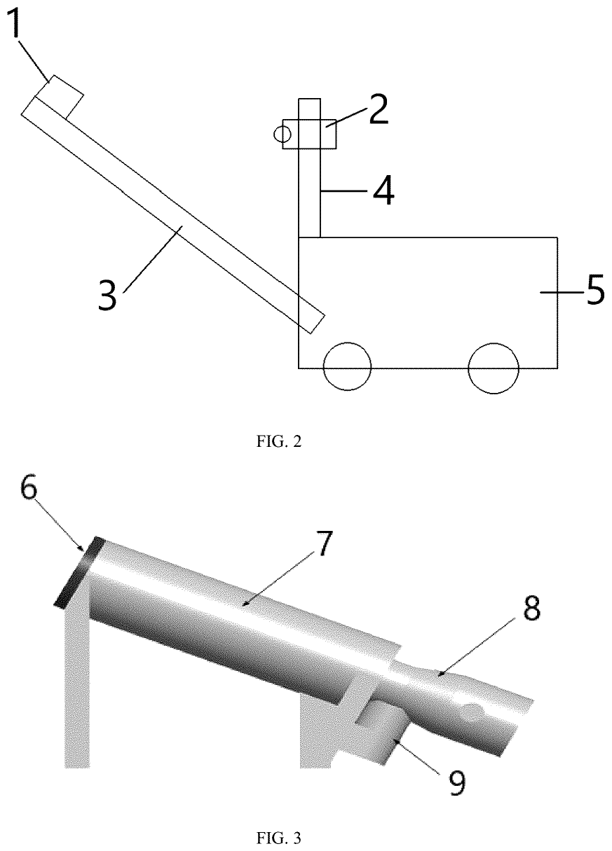

Further, as shown in FIG. 2, in the S1, the magnetometer 1 is mounted on a reel-type stretching rod 3 mechanism on a side face of the vehicle body, and the camera 2 is mounted on a mast 4 at a front end of the vehicle body, wherein the camera is a high resolution camera.

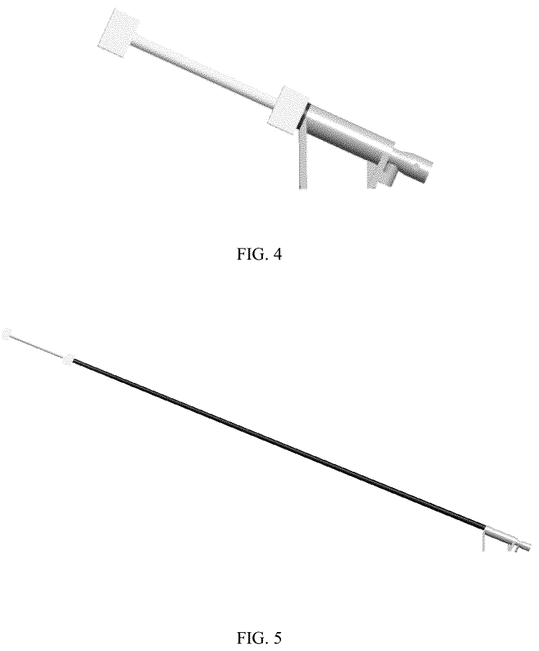

Further, an included angle between the stretching rod 3 and a traveling vehicle 5 is 45°, and the stretching rod 3 rotates and stretches out obliquely forward. As shown in FIG. 3, the stretching rod 3 includes: an elastic reel, an ejector rod assembly 6, an elastic reel storage tank 7, a cable winding cylinder 8, and a pin puller 9. The extension state of the stretching rod 3 is shown in FIG. 4, and a yellow part of a top of the stretching rod 3 is a mounting position of the magnetometer 1. The stretching rod 3 is extended by using a core elastic reel, a rigid structure is formed after the elastic reel is extended to serve as a support structure of the magnetometer 1, the extension diameter of the elastic reel storage tank 7 is greater than the forming diameter of the elastic reel, the elastic reel extends out of the elastic reel storage tank 7, the diameter is reduced, the elastic energy of the elastic reel is reduced, the released elastic energy serves as an extension driving force, and the extension state of the stretching rod 3 is shown in FIG. 5.

Further, the S5 specifically includes:
S51: preprocessing the image;
S52: calculating a gradient and an angle of the image to obtain a gradient image;
S53: performing non-maximum suppression on the gradient image;
S54: connecting edges by a double-threshold method to obtain edge detection results; and
S55: comparing the edge detection results to obtain the length and the angle of the stretching rod 3 in the on-orbit state.

Further, the preprocessing in the S51 specifically includes: firstly performing graying processing on the images to obtain a grayscale image, and performing Gaussian filtering with a kernel size of 5×5 on the grayscale image to obtain a preprocessed image. The graying specifically includes:

$${P}_{g} = 0.2126 R + 0.7125 G + B$$

wherein P_{g} represents the grayscale image, R represents a red gray value, G represents a green gray value, B represents a blue gray value, and the Gaussian filter is:

$$\frac{1}{273} \times [ \begin{matrix}1 & 4 & 7 & 4 & 7 \\ 4 & 16 & 26 & 16 & 4 \\ 7 & 26 & 41 & 26 & 7 \\ 4 & 16 & 26 & 16 & 4 \\ 1 & 4 & 7 & 4 & 7\end{matrix} ]$$

Further, the calculating a gradient and an angle of the image in the S52 specifically includes:

$${d}_{x} = [ \begin{matrix}- 1 & 0 & 1 \\ - 2 & 0 & 2 \\ - 1 & 0 & 1\end{matrix} ]$$

$${d}_{y} = [ \begin{matrix}- 1 & - 2 & - 1 \\ 0 & 0 & 0 \\ 1 & 2 & 1\end{matrix} ]$$

$$S = \sqrt{{d}_{x}^{2} + {d}_{y}^{2}}$$

$$θ = arctan ( \frac{{d}_{y}}{{d}_{x}} )$$

wherein dₓ is the gradient component of a pixel point in the x direction, d_{y} is the gradient component of a pixel point in the y direction, S is a gradient of a pixel point, and θ is an angle of a pixel point, wherein the direction of the gradient is divided into four directions of 0, 45, 90, and 135.

Further, the performing non-maximum suppression on the gradient image in the S53 specifically includes: for one pixel point A, comparing a gradient strength of the pixel point A with a gradient strength of a pixel point in positive and negative directions of a gradient of the pixel point A, if the gradient strength of the pixel point A is maximum, reserving the pixel point A, and if not, setting the gradient of the pixel point A to be 0.

Further, the double-threshold method in the S54 specifically includes: comparing a gradient of a pixel point with a preset first threshold value and a preset second threshold value, wherein the first threshold value is greater than the second threshold value; if the gradient of the pixel point is greater than the first threshold value, reserving the pixel point; if the gradient of the pixel point is less than the second threshold value, setting the gradient of the pixel point to be 0; if the gradient of the pixel point is less than the first threshold value and greater than the second threshold value, performing separate determination; wherein the first threshold value is greater than the second threshold value.

The separate determination specifically includes: if the pixel point that needs to be separately determined is adjacent to a pixel point with a gradient greater than the first threshold value, reserving this pixel point, and if not, setting the gradient of this pixel point to be 0.

Embodiments in this specification are all described in a progressive manner, for same or similar parts in embodiments, reference may be made to these embodiments, and each embodiment focuses on a difference from other embodiments.

The above description of the disclosed embodiments enables those skilled in the art to implement or use the present invention. Various modifications to these embodiments will be readily apparent to those skilled in the art, and the generic principles defined herein may be applied to other embodiments without departing from the spirit or scope of the present invention. Thus, the present invention is not intended to be limited to these embodiments shown herein but is to be accorded the broadest scope consistent with the principles and novel features disclosed herein.

What is claimed is:

1. A pose calibration method for an aerospace magnetometer, comprising the following steps:
S1: mounting a magnetometer and a camera on a vehicle body;
S2: in a ground state, completely expanding a stretching rod mounted on the vehicle body, and taking first photos from multiple angles by the camera in an Earth's full gravity mode;
S3: in a near-moon gravity mode, taking second photos from multiple angles by the camera;
S4: comparing the first photos in the Earth's full gravity mode with the second photos in the near-moon gravity mode to obtain a reference database; and
S5: repeating S2 and S3 in an on-orbit state, and comparing a photographing result with the reference database to obtain a length and an angle of the stretching rod.

2. The pose calibration method for the aerospace magnetometer according to claim 1, wherein in the S1, the magnetometer is mounted on a reel-type stretching rod mechanism on a side face of the vehicle body, and the camera is mounted on a mast at a front end of the vehicle body.

3. The pose calibration method for the aerospace magnetometer according to claim 1, wherein an included angle between the stretching rod and a traveling vehicle is 45°, and the stretching rod rotates and stretches out obliquely forward.

4. The pose calibration method for the aerospace magnetometer according to claim 1, wherein the S5 comprises:
S51: preprocessing an image;
S52: calculating a gradient and an angle of the image to obtain a gradient image;
S53: performing non-maximum suppression on the gradient image;
S54: connecting edges by a double-threshold method to obtain edge detection results; and
S55: comparing the edge detection results to obtain the length and the angle of the stretching rod in the on-orbit state.

5. The pose calibration method for the aerospace magnetometer according to claim 4, wherein the preprocessing in the S51 comprises: firstly performing graying processing on the image to obtain a grayscale image, and performing Gaussian filtering with a kernel size of 5×5 on the grayscale image to obtain a preprocessed image.

6. The pose calibration method for the aerospace magnetometer according to claim 4, wherein the performing non-maximum suppression on the gradient image in the S53 comprises: for one pixel point A, comparing a gradient strength of the pixel point A with a gradient strength of a pixel point in positive and negative directions of a gradient of the pixel point A, if the gradient strength of the pixel point A is maximum, reserving the pixel point A, and if not, setting the gradient of the pixel point A to be 0.

7. The pose calibration method for the aerospace magnetometer according to claim 4, wherein the double-threshold method in the S54 comprises: comparing a gradient of a pixel point with a preset first threshold value and a preset second threshold value, wherein the preset first threshold value is greater than the preset second threshold value; if the gradient of the pixel point is greater than the preset first threshold value, reserving the pixel point; if the gradient of the pixel point is less than the preset second threshold value, setting the gradient of the pixel point to be 0; if the gradient of the pixel point is less than the preset first threshold value and greater than the preset second threshold value, performing separate determination; wherein the preset first threshold value is greater than the preset second threshold value.
